(19) United States
(12) Patent Application Publication
(10) Pub. No.: US 2022/0306076 A1
(43) Pub. Date: Sep. 29, 2022

(54) SYSTEMS AND METHODS TO AVOID UNDESIRABLE VEHICLE OPERATIONS INSIDE A CONFINED SPACE

(71) Applicant: Ford Global Technologies, LLC, Dearborn, MI (US)

(72) Inventors: Brendan Diamond, Grosse Pointe, MI (US); Keith Weston, Canton, MI (US)

(73) Assignee: Ford Global Technologies, LLC, Dearborn, MI (US)

(21) Appl. No.: 17/211,779

(22) Filed: Mar. 24, 2021

(51) Int. Cl. B60W 20/16; B60W 20/17; B60K 6/28; B60W 50/14; H04W 4/021

(52) U.S. Cl. CPC B60W 20/16; B60W 20/17; B60K 6/28; B60W 50/14; H04W 4/021; B60W 2710/06; B60W 2552/05; B60W 2510/244; B60Y 2200/92; B60W 2050/146; B60W 2420/40; B60W 2555/20

(57) ABSTRACT

This disclosure is generally directed to systems and methods for avoiding certain undesirable vehicle operations when a vehicle having a dual vehicle propulsion system is parked inside a confined space. For example, it is desirable to avoid operating an internal combustion engine of a hybrid electric vehicle when the hybrid electric vehicle is parked inside a garage because the internal combustion engine may produce undesirable gaseous emissions, particularly during start up. In an example embodiment, this issue is addressed by a computer of the vehicle defining a geofence that encompasses the garage. The computer disables the operation of the internal combustion engine when the hybrid electric vehicle is located inside the geofence but allows operation of an electric motor of the hybrid electric vehicle for moving the vehicle out of the geofence. The computer enables operation of the internal combustion engine when the vehicle has moved outside the geofence.

### BACKGROUND

Gaseous emissions may be produced by internal combustion engines. It is preferred not to emit gaseous emissions in an enclosed space. One way to address this issue involves replacing vehicles having internal combustion engines with electric vehicles. However, factors such as cost and battery range, may discourage some people from purchasing electric vehicles. Consequently, some automobile manufacturers offer a compromise solution in the form of a hybrid vehicle that includes an internal combustion engine and an electric motor drive system. The hybrid vehicle may allay certain reservations that people may have with respect to electric vehicles. Nonetheless, it is desirable to minimize gaseous emissions when the hybrid vehicle is located in a confined space.

### DESCRIPTION OF THE FIGS.

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

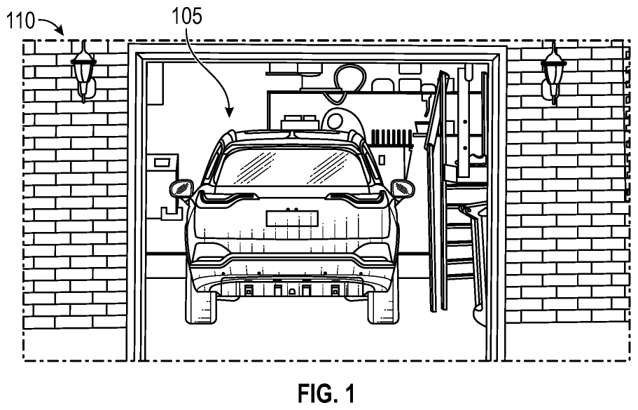

FIG. 1 shows a first example scenario in accordance with the disclosure where a vehicle is parked inside a residential garage.

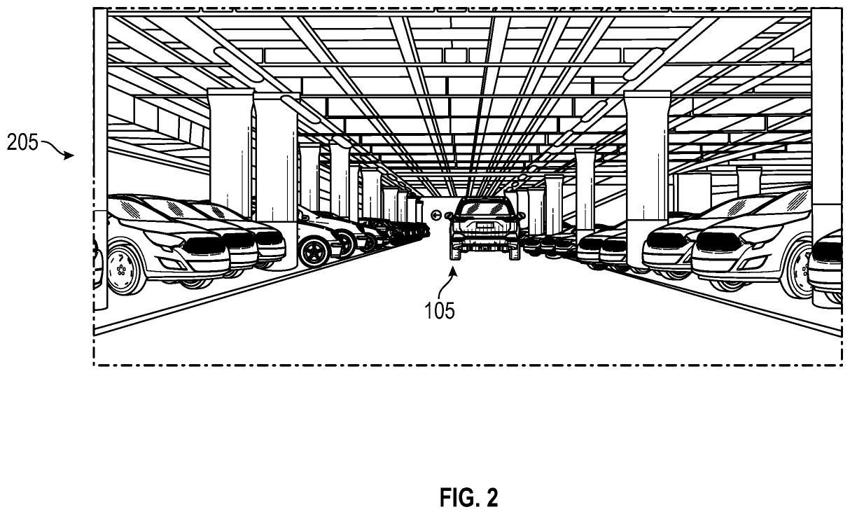

FIG. 2 shows a second example scenario in accordance with the disclosure where a vehicle is seeking an unoccupied parking spot inside a covered parking lot.

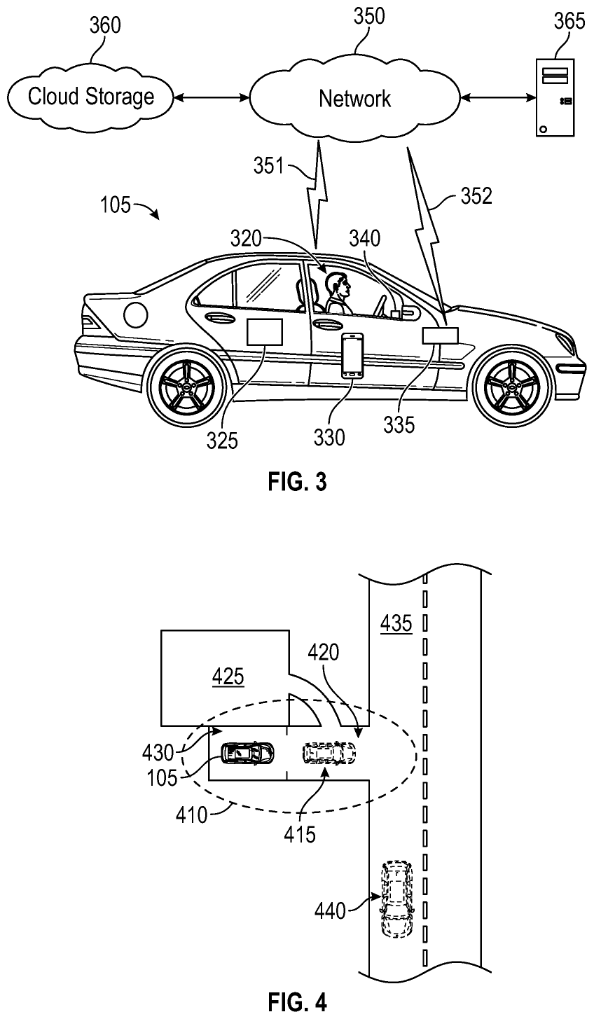

FIG. 3 shows some example components that may be provided in a vehicle in accordance with an embodiment of the disclosure.

FIG. 4 illustrates a scenario where a vehicle utilizes a first example geofence to execute some operations in accordance with the disclosure.

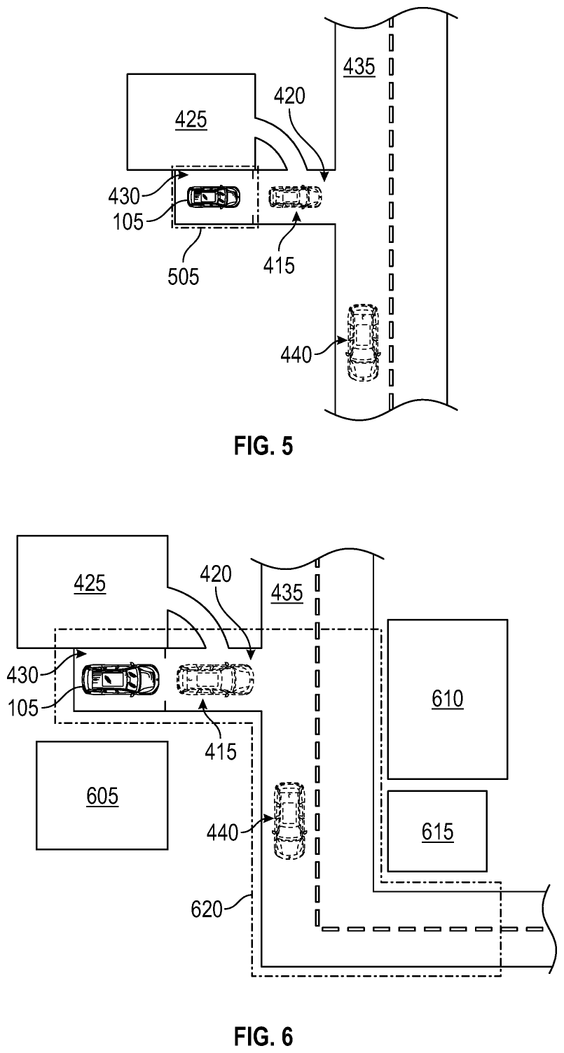

FIG. 5 illustrates a scenario where a vehicle utilizes a second example geofence to execute some operations in accordance with the disclosure.

FIG. 6 illustrates a scenario where a vehicle utilizes a third example geofence to execute some operations in accordance with the disclosure.

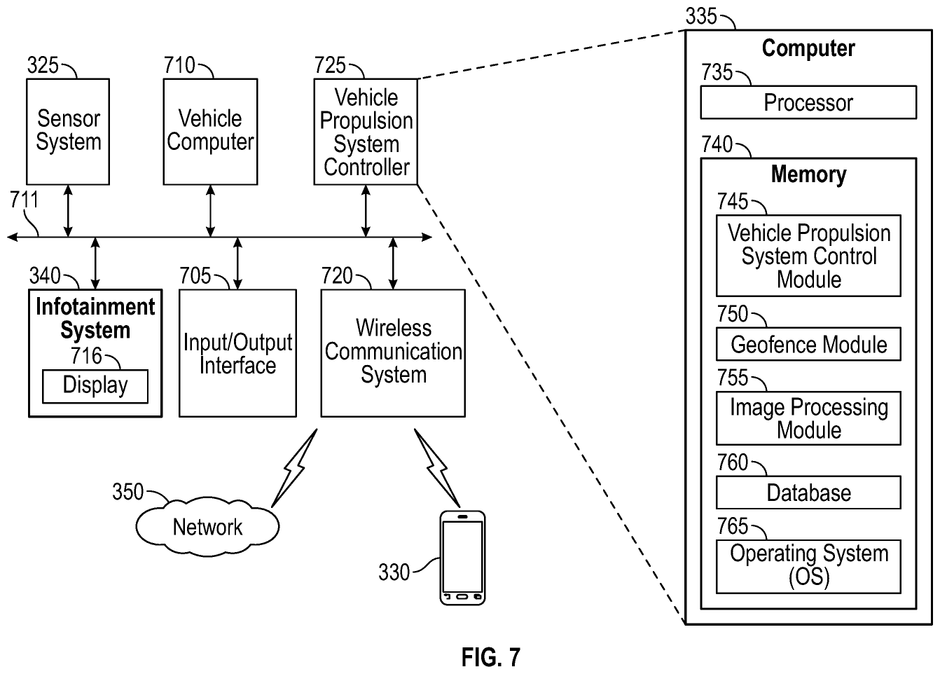

FIG. 7 shows some example components that may be included in a vehicle to execute some operations in accordance with the disclosure.

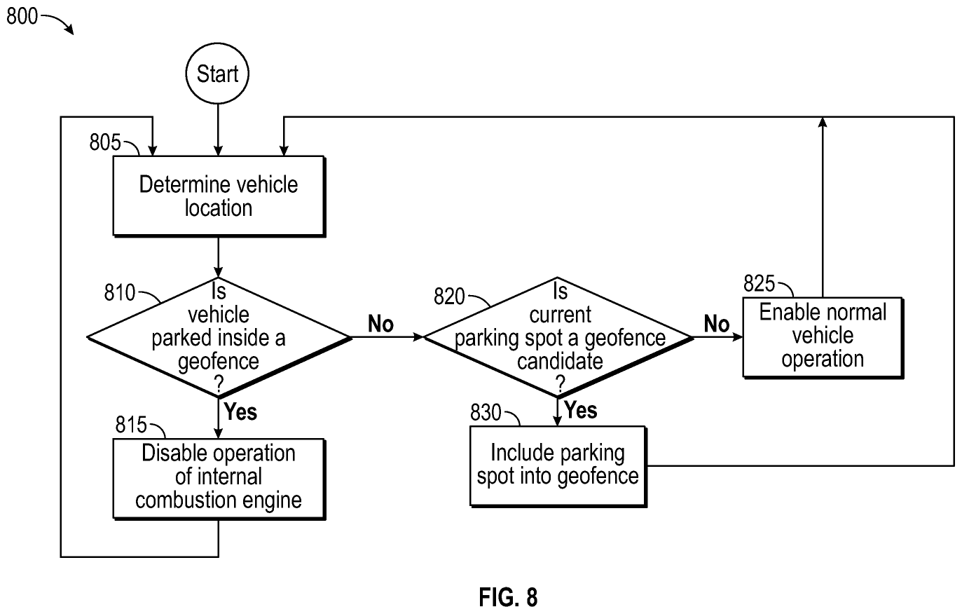

FIG. 8 shows a flowchart of an example method to use a geofence to execute some operations in accordance with the disclosure.

### DETAILED DESCRIPTION

### Overview

This disclosure is generally directed to systems and methods for avoiding certain undesirable vehicle operations when a vehicle having a dual vehicle propulsion system is parked inside a confined space. For example, it is desirable to avoid operating an internal combustion engine of a hybrid electric vehicle when the hybrid electric vehicle is parked inside a garage because the internal combustion engine may produce undesirable gaseous emissions, particularly during start up. In an example embodiment, this issue is addressed by a computer of the vehicle defining a geofence that encompasses the garage. The computer disables the operation of the internal combustion engine when the hybrid electric vehicle is located inside the geofence, but allows operation of an electric motor of the hybrid electric vehicle for moving the vehicle out of the geofence. The computer enables operation of the internal combustion engine when the vehicle has moved outside the geofence.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionalities described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and labels are used herein solely for convenience and such words and labels should be interpreted as referring to various objects and actions that are generally understood in various forms and equivalencies by persons of ordinary skill in the art. For example, the word “vehicle” as used in this disclosure can pertain to any of various types of vehicles, such as, for example, a car, a van, a sports utility vehicle, a truck, an alternative energy vehicle, a driver-operated vehicle, or an autonomous vehicle. The phrase “undesirable operations” as used herein is not limited exclusively to gaseous emissions by a vehicle but also encompasses various other undesirable aspects of vehicle operations such as, for example, sound pollution created by the vehicle. The phrase “vehicle propulsion system” as used herein encompasses any of various types of systems used to move a vehicle, such as, for example, an internal combustion engine (ICE) drive system, an electric drive system, a hydrogen drive system, a propane drive system, a compressed natural gas (CNG) drive system, a diesel engine drive system, a fuel cell drive system, a solar cell drive system, and a biodiesel drive system.

More particularly, the various embodiments described herein pertain to a vehicle having multiple vehicle propulsion systems. Each of the multiple vehicle propulsion systems may be operated on the basis of various conditions such as, for example, the use of an ICE drive engine when a charge level in a battery of a hybrid electric vehicle drops below a threshold charge level. It should be understood that the various embodiments described herein refer to an internal combustion engine merely as one example vehicle propulsion system that may generate undesirable gaseous emissions and sound pollution. However, some other vehicle propulsion systems may be associated with similar and/or different, undesirable operations, such as, for example, undesirable gas emissions by a CNG drive system or sound pollution generated by a diesel engine. Consequently, it must be understood that the description provided herein with respect to a hybrid electric vehicle is equally applicable to various other vehicles having multiple vehicle propulsion systems. It must also be understood that the word “example” as used herein is intended to be non-exclusionary and non-limiting in nature and labels such as “example implementation,” “example scenario,” and “example case,” as used herein should be interpreted as directed at example descriptions of various aspects of the disclosure.

FIG. 1 shows a first example scenario in accordance with the disclosure where a hybrid electric vehicle 105 is parked inside a garage 110 that may be a part of a residence. The garage 110 is one example of a confined space where it is desirable to avoid certain operations in accordance with the disclosure. Other examples of a confined space may be a car port attached to the residence or a garage that is an independent building located away from the residence.

The hybrid electric vehicle 105 has two vehicle propulsion systems—an internal combustion engine and an electric motor. It is desirable for various reasons to avoid operating the internal combustion engine when the hybrid electric vehicle 105 is parked in the garage 110. The reasons can include, for example, avoiding gaseous emissions from accumulating in the garage 110 or seeping into the residence, and/or avoiding sound emissions that may disturb the occupants of the residence or neighbors. The gaseous emissions and/or sound emissions can be particularly excessive and undesirable if the internal combustion engine were to be activated during startup of the hybrid electric vehicle 105 inside the garage 110. Consequently, a computer (not shown) of the hybrid electric vehicle 105 is configured in accordance with the disclosure to disable operation of the internal combustion engine when the hybrid electric vehicle 105 is parked in the garage 110.

FIG. 2 shows a second example scenario in accordance with the disclosure where the hybrid electric vehicle 105 is seeking an unoccupied parking spot inside a covered parking lot 205. The covered parking lot 205 can be a public garage or a private garage where a number of vehicles are parked. Many of the parking spots in the covered parking lot 205 may be already occupied. Hence, the hybrid electric vehicle 105 has to move around to find an unoccupied parking spot. It is desirable to avoid operating the internal combustion engine of the hybrid electric vehicle 105 when moving around the covered parking lot 205 for reasons such as to avoid gaseous emissions and sound pollution. If an unoccupied parking spot is found, it is further desirable to avoid operating the internal combustion engine of the hybrid electric vehicle 105 when the hybrid electric vehicle 105 starts up and moves out of the parking spot later on.

The computer (not shown) of the hybrid electric vehicle 105 is configured in accordance with the disclosure to disable operation of the internal combustion engine during various time periods such as when the hybrid electric vehicle 105 is cruising around inside the covered parking lot 205, when starting up after parking in a parking spot inside the covered parking lot 205, when entering the covered parking lot 205, and/or when exiting the covered parking lot 205. In some instances, the internal combusiton engine of the hybrid electric vehicle 105 may be turned off or turned on based on the trajectory of the vehicle. For example, if the vehicle is driving towards a covered parking lot, garage, crowded location, high pollution location, quite zone, or the like, the internal combustion engine may be turned off.

FIG. 3 shows some example components that may be provided in the hybrid electric vehicle 105 in accordance with the disclosure. The example components can include a computer 335, an infotainment system 340, and a sensor system 325. In the illustrated example scenario, the hybrid electric vehicle 105 is operated by a driver 320 who carries a personal communications device 330. In another example scenario, the hybrid electric vehicle 105 can be an autonomous vehicle.

The computer 335, which can be an independent device or can be a part of a vehicle computer that controls various operations of the hybrid electric vehicle 105, is configured to execute various operations in accordance with the disclosure. The various operations can include, for example, generating a geofence encompassing a place such as the garage 110 or the covered parking lot 205, disabling the internal combustion engine of the hybrid electric vehicle 105 when the hybrid electric vehicle 105 is located inside the geofence, and enabling the internal combustion engine of the hybrid electric vehicle 105 when the hybrid electric vehicle 105 is located outside the geofence.

The infotainment system 340 may be communicatively coupled to the computer 335 and may include a display screen for displaying information provided by the computer 335. The information can include, for example, instructions and/or alerts directed at the driver 320.

The sensor system 325 can include various types of devices such as, for example, a digital camera, a video camera, an ultrasonic sensor, a light detection and ranging (LIDAR) device, and/or a light sensor. The devices may be configured to provide information to the computer 335 for various purposes such as, for example, to detect whether the hybrid electric vehicle 105 is located inside the garage 110 or is located outside the garage 110. The sensor system 325 may further include devices such as a battery current-draw sensor and a battery-to-gasoline engine switchover sensor. The battery current-draw sensor may be configured to communicate to the computer 335, information regarding a level of charge available in a battery of the hybrid electric vehicle 105. The computer 335 may use this information to determine whether the hybrid electric vehicle 105 can be operated by the electric motor system of the hybrid electric vehicle 105. The battery-to-gasoline engine switchover sensor may be configured to communicate to the computer 335, information pertaining to a switchover from the electric motor system of the hybrid electric vehicle 105 to the internal combustion engine (or vice-versa).

The personal communications device 330, which can be any of various devices such as, for example, a smartphone, a tablet computer, a laptop computer, or a wearable device, can be configured to communicate with the computer 335 (using any of various communication technologies such as, for example, cellular, Bluetooth®, near-field communication (NFC), Wi-Fi, or Wi-Fi direct) for performing various operations in accordance with the disclosure. In an example scenario, the computer 335 may detect a low battery charge in a battery of the hybrid electric vehicle 105 and may transmit an instruction to the driver 320 to charge the battery prior to attempting to start the hybrid electric vehicle 105. The instruction is directed at ensuring that the low battery charge does not result in the internal combustion engine being operated during startup of the hybrid electric vehicle 105.

The computer 335 can also communicate via a network 350 with various devices such as, for example, a server computer 365 and cloud storage 360. In an example implementation, the server computer 365 may be configured to execute some or all operations in accordance with the disclosure, in lieu of, or in cooperation with, the computer 335. Consequently, some or all of the software that is provided in the server computer 365 may be replicated, supplemented, or complemented by software provided in the computer 335.

Cloud storage 360 may be used for storing various kinds of data that can be used by the computer 335 and/or the server computer 365 for executing some or all operations in accordance with the disclosure. In an example scenario, information pertaining to a geofence that is configured for executing various operations in accordance with the disclosure may be stored in the cloud storage 360 and/or in the server computer 365. The various processes and operations may be executed at the vehicle and/or over the cloud via the server computer or a cluster of computers over the cloud.

The network 350 may include any one or a combination of various networks such as a local area network (LAN), a wide area network (WAN), a telephone network, a cellular network, a cable network, a wireless network, and/or private/public networks such as the Internet. The various components that are communicatively coupled to the network 350 may communicate with each other by using various communication technologies such as, for example, TCP/IP, Bluetooth®, cellular, near-field communication (NFC), Wi-Fi, Wi-Fi direct, vehicle-to-vehicle (V2V) communication, and/or vehicle-to-infrastructure (V2I) communication.

More particularly, a portion of the network 350 supports a wireless link 351 that may be used by the personal communication device 330 to communicate with the server computer 365 and/or the cloud storage 360. Another portion of the network 350 supports a wireless link 352 that may be used by the computer 335 to communicate with the server computer 365 and/or the cloud storage 360. In an example implementation, the wireless link 351 can support cellular communications and the wireless link 352 can support vehicle-to-infrastructure (V2I) communications.

FIG. 4 illustrates a scenario where the hybrid electric vehicle 105 utilizes an example geofence to implement some operations in accordance with the disclosure. The geofence can have any of various shapes and dimensions in various embodiments. In this example embodiment, the geofence 410 has an oval shape and encompasses the garage 430 that is attached to a residence 425. The geofence 410 further encompasses a driveway 420 that extends from the garage 430 to a road 435 that runs perpendicular to the driveway 420.

The geofence 410 may be created in various ways in accordance with the disclosure. In a first example embodiment, the geofence 410 may be created by the computer 335 based on input provided by an individual such as, for example, the driver 320 of the hybrid electric vehicle 105. The individual may provide input via a graphical user interface (GUI) of the infotainment system 340 or via the personal communications device 330. In an example scenario, the individual may sketch an outline of the geofence 410 as an overlay upon a graphical representation of the residence 425, the garage 430, the driveway 420, and the road 435.

In a second example embodiment, the geofence 410 may be automatically created by the computer 335 based on data collected by the computer 335. The data, which may include, for example, architectural details of the residence 425, the garage 430, and surrounding areas, may be obtained by the computer 335 from various sources such as, for example, from the server computer 365, from cloud storage 360, and/or from the sensor system 325. Data obtained from the sensor system 325 can include various images captured by a camera, distance information produced by an ultrasonic sensor, and/or light intensity levels measured by a light sensor at various times. The images may indicate that the hybrid electric vehicle 105 is parked on the driveway 420 over a first period of time and inside the garage 430 over a second period of time. Distance information provided by the ultrasonic sensor may indicate a typically parking distance of the hybrid electric vehicle 105 with respect to a door of the garage 430. Light sensor information may indicate that the first period of time during which the hybrid electric vehicle 105 is parked on the driveway 420 corresponds to daylight and the second period of time during which the hybrid electric vehicle 105 is parked inside the garage 430 corresponds to night time.

In an example implementation of this embodiment, the computer 335 may utilize a learning procedure to obtain information from the collected data. Thus, for example, the computer 335, may utilize a learning procedure to evaluate data obtained from the sensor system 325 over a period of time (hours of the day, days of the week, etc.) and identify a parking spot where the hybrid electric vehicle 105 is typically parked over the period of time.

In a third example embodiment, the geofence 410 may be automatically created by the computer 335 based on vehicle travel information. The vehicle travel information may be provided to the computer by a global positioning system (GPS) device located in the hybrid electric vehicle 105. The information provided by the GPS device may indicate to the computer 335 that the hybrid electric vehicle 105 is typically parked at a work location during a work day and is parked overnight on the driveway 420 or on the road 435. In some cases, the computer 335 may utilize a learning procedure to obtain information from the vehicle travel information.

Irrespective of the way by which the geofence 410 is created, the computer 335 may utilize the geofence 410 to prevent the hybrid electric vehicle 105 from performing various undesirable operations. In an example operation in accordance with the disclosure, the computer 335 disables operation of the internal combustion engine of the hybrid electric vehicle 105 when the hybrid electric vehicle 105 is located inside the geofence 410 such as, for example, when parked inside the garage 430, or when parked on the driveway 420 (illustrated in the form of a dashed line icon 415). The computer 335 enables operation of the internal combustion engine of the hybrid electric vehicle 105 when the hybrid electric vehicle 105 is located outside the geofence 410 such as, for example, when the hybrid electric vehicle 105 moves out of the driveway 420 and travels on the road 435 (illustrated in the form of a dashed line icon 440).

FIG. 5 illustrates another scenario where the hybrid electric vehicle 105 utilizes an example geofence 505 to implement some operations in accordance with the disclosure. The example geofence 505, which has a rectangular shape and encompasses the garage 430 that is attached to the residence 425, may be defined on the basis of preventing gaseous emissions (e.g., exhaust via the tailpipe and muffler) and sound emissions (e.g., via the tailpipe and muffler) of the hybrid electric vehicle 105 from entering the residence 425.

In an example operation in accordance with the disclosure, the computer 335 disables operation of the internal combustion engine of the hybrid electric vehicle 105 when the hybrid electric vehicle 105 is located inside the geofence 505 particularly when parked inside the garage 430. The computer 335 enables operation of the internal combustion engine of the hybrid electric vehicle 105 when the hybrid electric vehicle 105 is located outside the geofence 505 such as, for example, when the hybrid electric vehicle 105 is parked on the driveway 420 (illustrated in the form of the dashed line icon 415) or is traveling on the road 435 (illustrated by the dashed line icon 440).

FIG. 6 illustrates yet another scenario where the hybrid electric vehicle 105 utilizes an example geofence 620 to implement some operations in accordance with the disclosure. The example geofence 620 has an irregular shape that encompasses the garage 430, the driveway 420, a portion of the road 435, and a portion of a road 630. The geofence 620 may be defined not only on the basis of preventing gaseous emissions and sound emissions of the hybrid electric vehicle 105 from entering the residence 425 but also on the basis of preventing sound emissions of the hybrid electric vehicle 105 from disturbing residents of neighboring residences (residence 605, residence 610, and residence 615) that may be located inside a subdivision, for example. The road 630 may lead to an entrance of the subdivision.

In an example operation in accordance with the disclosure, the computer 335 disables operation of the internal combustion engine of the hybrid electric vehicle 105 when the hybrid electric vehicle 105 is located inside the geofence 620, particularly when the hybrid electric vehicle 105 is moving inside the subdivision. The computer 335 enables operation of the internal combustion engine of the hybrid electric vehicle 105 when the hybrid electric vehicle 105 is located outside the geofence 620 such as, for example, after exiting the subdivision via the road 630.

FIG. 7 shows some example components that may be included in the hybrid electric vehicle 105. The exemplary components may include the sensor system 325, a vehicle computer 710, a vehicle propulsion system controller 725, the infotainment system 340, an input/output interface 705, and a wireless communication system 720. The various components are communicatively coupled to each other via one or more buses such as, for example, a bus 711. The bus 711 may be implemented using various wired and/or wireless technologies. For example, the bus 711 can be a vehicle bus that uses a controller area network (CAN) bus protocol, a Media Oriented Systems Transport (MOST) bus protocol, and/or a CAN flexible data (CAN-FD) bus protocol. Some or all portions of the bus 711 may also be implemented using wireless technologies such as Bluetooth®, Bluetooth®, Ultra-Wideband, Wi-Fi, Zigbee®, or near-field-communications (NFC). For example, the bus 711 may include a Bluetooth® communication link that allows the sensor system 325 to transmit sensor signals to the vehicle propulsion system controller 725 and/or to the computer 335.

The sensor system 325 can include various types of sensors such as, for example, a digital camera, a video camera, an ultrasonic sensor, a light detection and ranging (LIDAR) device, and/or a light sensor. The sensors may provide sensor signals to the vehicle propulsion system controller 725 via the bus 711. The sensor system 325 may further include other sensors such as a battery current-draw sensor and a battery-to-gasoline engine switchover sensor. The battery current-draw sensor may be configured to communicate to the computer 335, information regarding a level of charge available in a battery of the hybrid electric vehicle 105. The computer 335 may use this information to determine whether the hybrid electric vehicle 105 can be operated by the electric motor system of the hybrid electric vehicle 105. The battery-to-gasoline engine switchover sensor may be configured to communicate to the computer 335, information pertaining to a switchover from the electric motor system of the hybrid electric vehicle 105 to the internal combustion engine (or vice-versa).

The vehicle computer 710 may perform various functions such as controlling operations of the internal combustion engine and/or the electric motor of the hybrid electric vehicle 105 (switch-over, battery level checking, fuel injection, speed control, emissions control, braking, etc.), managing climate controls (air conditioning, heating etc.), activating airbags, and issuing warnings (check engine light, bulb failure, low tire pressure, vehicle in blind spot, etc.). In some cases, the vehicle computer 710 may include more than one computer such as, for example, a first computer that controls engine operations and a second computer that operates the infotainment system 340.

The infotainment system 340 can include a display screen 716 having a GUI for carrying out various operations. The GUI may be used, for example, by an individual, such as, for example, the driver 320 to provide input pertaining to a geofence. The input may be propagated via the bus 711 to the computer 335, which can be a part of the vehicle propulsion system controller 725, for use in defining a geofence in accordance with the disclosure. The display screen 716 may also be used to convey information to the driver 320 and/or other occupants of the hybrid electric vehicle 105. In an example scenario, the display screen 716 may be used by the computer 335 to display an instruction to the driver 320 to charge the battery prior to attempting to start the hybrid electric vehicle 105. The instruction is directed at ensuring that the internal combustion engine is not operated inside a geofence during startup of the hybrid electric vehicle 105 as a result of the low battery charge.

The input/output interface 705 can receive various types of information that may be conveyed to the computer 335 via the bus 711, and can provide output information from the computer 335. In an example implementation, the input/output interface 705 can be used to automatically receive various types of information from various sources. For example, the input/output interface 705 can be communicatively coupled to a Global Positioning System (GPS) system of the hybrid electric vehicle 105 to automatically receive map information. The map information can be stored in a database of the computer 335 and used for generating a geofence.

The wireless communication system 720 may be configured to provide communications with the personal communications device 330 of the driver 320 and various other devices (via the network 350 shown in FIG. 3).

The vehicle propulsion system controller 725 can include the computer 335 as well as hardware and/or software to allow the vehicle propulsion system controller 725 to interact with the vehicle computer 710 for executing various functions such as, for example, disabling/enabling the internal combustion engine. The computer 335 can include a processor 735 and a memory 740. The memory 740, which is one example of a non-transitory computer-readable medium, may be used to store an operating system (OS) 765 and various code modules such as a vehicle propulsion system control module 745, a geofence module 750, and an image processing module 755. The memory 740 may also include a database 760.

The vehicle propulsion system control module 745 may be executed by the processor 735 for performing various operations in accordance with the disclosure. In an example scenario, the processor 735 may execute the vehicle propulsion system control module 745 for generating a geofence and/or for enforcing the geofence. The geofence may be generated by execution of the geofence module 750. The geofence module 750 may utilize various forms of data for this purpose, such as, for example, input provided by the driver 320 (via the infotainment system 340), data received from the server computer 365 and/or cloud storage 360 (via the network 350), location data received from a GPS device (via the input/output interface 705), and/or sensor data received from the sensor system 325.

In an example scenario, sensor data received from the sensor system 325 can be an image of an object (garage interior, garage door, driveway, road, a residence, a building, a landmark, etc.). The image may be processed by execution of the image processing module 755 and information derived may be used by the vehicle propulsion system control module 745 for various purposes, such as, for example, to generate a geofence, to disable an internal combustion engine when the hybrid electric vehicle 105 is located inside a geofence, and/or to enable the internal combustion engine when the hybrid electric vehicle 105 is located outside the geofence.

Data and/or information pertaining to items such as, for example, a geofence, a hybrid electric vehicle, a residence, and/or a parking spot may be stored in the database 760 and accessed by the processor 735 when executing the vehicle propulsion system control module 745.

FIG. 8 shows an example flowchart 800 of an example method to avoid undesirable vehicle operations inside a confined space in accordance with the disclosure. The example flowchart 800 illustrates a sequence of operations that can be implemented in hardware, software, or a combination thereof. In the context of software, the operations represent computer-executable instructions stored on one or more non-transitory computer-readable media such as the memory 740, that, when executed by one or more processors such as the processor 735, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the exemplary flowchart 800 may be carried out by using an application stored in the memory 740 and executed by the processor 735 of the computer 335. It must be understood that the various objects referred to above (and illustrated in the figures) are used below merely as example objects for purposes of describing the flowchart 800 and that the description is equally applicable to various other objects and embodiments.

At block 805, the computer 335 determines a current location of the hybrid electric vehicle 105. The determination may be carried out in various ways such as, for example, by evaluating information received from the sensor system 325 and/or based on location information received from a GPS device. The information received from the sensor system 325 can include, for example, images captured by a camera of the sensor system 325. The images can include, for example, an image of a door of the garage 430, an interior wall of the garage 430, an image of a building (such as, for example, the residence 425 and/or the residence 605), and/or an image of a landmark.

At block 810, the computer 335 may determine whether the hybrid electric vehicle 105 is located inside a geofence. In an example scenario, the determination may be made by evaluating images captured by a camera of the sensor system 325 to identify and compare the current location of the hybrid electric vehicle 105 with geofence information stored in the database 760, for example. In another example scenario, determining that the vehicle is parked inside a confined space located inside a geofence may be made by comparing a light intensity level outside the hybrid electric vehicle 105 to a reference light level, the reference light level based on a time of day at which the determination is made.

If the hybrid electric vehicle 105 is located inside a geofence, at block 815, the computer 335 disables operation of an internal combustion engine of the hybrid electric vehicle 105. In an example scenario, at block 815, the computer 335 may make an exception and allow operation of the internal combustion engine for a period of time so as to allow the driver 320 of the hybrid electric vehicle 105 to charge a depleted battery in the hybrid electric vehicle 105. This battery charging operation may be carried out in spite of the hybrid electric vehicle 105 being located inside the geofence so as to allow the electric motor of the hybrid electric vehicle 105 to be used for startup of the hybrid electric vehicle 105 later on. The battery charging operation in this scenario may be performed after certain precautionary measures are taken to minimize adverse effects of gaseous emissions and/or sound emissions. These precautionary measures may include, for example, closing a door leading into a residence and/or opening a window in a garage to provide ventilation.

After disabling of the internal combustion engine, the computer 335 continues to determine a current location of the hybrid electric vehicle 105 (as indicated in block 805). In an example scenario, the hybrid electric vehicle 105 may move out of the geofence. Consequently, at block 810, the computer 335 determines that the hybrid electric vehicle 105 is no longer located inside the geofence.

At block 820, the computer 335 may make a determination whether the current location of the hybrid electric vehicle 105 is a parking spot that may be a geofence candidate. In an example scenario, the hybrid electric vehicle 105 may be parked outside the geofence 410 on the road 435 (shown in FIG. 4) and close to a sidewalk. The computer 335 may obtain various documents and information from sources such as, for example, the cloud storage 360, and evaluate the documents and/or information to verify that the current parking spot is a valid parking spot. An example document may be a county ordinance or a police permit. In another example scenario, the hybrid electric vehicle 105 may be parked in a covered parking lot of a medical facility. The computer 335 may use historical information (accumulated over a period of time) to determine that the driver 320 of the hybrid electric vehicle 105 works in the medical facility and it is desirable to include the closed parking lot inside a geofence for purposes of eliminating sound pollution.

If the current parking spot of the hybrid electric vehicle 105 is a geofence candidate, at block 830, the current parking spot is included into a geofence. Inclusion of the parking spot into a geofence may be accomplished in various ways such as, for example, by generating a new geofence or by modifying an existing geofence. After including the parking spot into the geofence, the computer 335 may determine a current location of the hybrid electric vehicle 105 (as indicated in block 805), followed by actions indicated in subsequent blocks.

If the current parking spot of the hybrid electric vehicle 105 is not a geofence candidate, at block 825, the computer 335 enables normal operations of the hybrid electric vehicle 105. Normal operations of the hybrid electric vehicle 105 includes enabling operation of the internal combustion engine of the hybrid electric vehicle 105. After enabling normal operations of the hybrid electric vehicle 105, the computer 335 determines a current location of the hybrid electric vehicle 105 (as indicated in block 805), followed by actions indicated in subsequent blocks.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such labels or phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device, such as the memory 740 provided in the computer 335, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, personal communication devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiment.

That which is claimed is:

1. A method comprising:
determining a geofence that encompasses a confined space; and
disabling, inside the confined space, operation of a first vehicle propulsion system of a vehicle in order to prevent gaseous emissions and/or sound emissions by the first vehicle propulsion system.

2. The method of claim 1, wherein the first vehicle propulsion system is an internal combustion engine.

3. The method of claim 2, wherein the geofence is defined based on input provided by an individual, and wherein the sound emissions by the first vehicle propulsion system comprises a sound produced by the internal combustion engine.

4. The method of claim 2, wherein the confined space is one of a garage or a covered parking lot, and wherein the method further comprises:
detecting a location of the vehicle outside the geofence; and
enabling operation of the internal combustion engine based on detecting the location of the vehicle outside the geofence.

5. The method of claim 1, wherein the vehicle is a hybrid electric vehicle that includes a second vehicle propulsion system comprising a battery coupled to an electric motor, the method further comprising:
determining that a charge level of the battery is below a threshold level; and
enabling, inside the confined space, operation of the first vehicle propulsion system based on determining that the charge level of the battery is below the threshold level.

6. The method of claim 1, wherein the vehicle is a hybrid electric vehicle that includes a second vehicle propulsion system comprising a battery coupled to an electric motor, the method further comprising:
determining that a charge level of the battery is below a threshold level; and
displaying, upon a display screen of an infotainment system in the vehicle and/or a personal communications device, an instruction to charge the battery before the vehicle is started.

7. The method of claim 1, wherein disabling the first vehicle propulsion system of the vehicle is based on determining that the vehicle is parked inside the confined space.

8. The method of claim 7, wherein determining that the vehicle is parked inside the confined space comprises comparing a light intensity level outside the vehicle to a reference light level, the reference light level based on a time of day.

9. A method comprising:
determining that a vehicle is parked inside a confined space; and
disabling, inside the confined space, operation of a first vehicle propulsion system of the vehicle in order to prevent gaseous emissions and/or sound emissions by the first vehicle propulsion system.

10. The method of claim 9, wherein the first vehicle propulsion system comprises an internal combustion engine, and the method further comprises:
defining a geofence that encompasses the confined space and an area outside the confined space;
detecting a location of the vehicle in the area outside the geofence; and
enabling operation of the internal combustion engine based on detecting the location of the vehicle in the area outside the geofence.

11. The method of claim 10, wherein the confined space is a garage and the area outside the garage comprises one of a driveway or a road.

12. The method of claim 9, wherein the first vehicle propulsion system comprises an internal combustion engine and wherein the vehicle is a hybrid electric vehicle that includes a second vehicle propulsion system comprising a battery coupled to an electric motor, the method further comprising:
determining that a charge level of the battery is below a threshold level; and
enabling, inside the confined space, operation of the first vehicle propulsion system based on determining that the charge level of the battery is below the threshold level.

13. The method of claim 9, wherein disabling the first vehicle propulsion system of the vehicle is based on determining that the vehicle is parked inside the confined space.

14. The method of claim 13, wherein determining that the vehicle is parked inside the confined space comprises comparing a light intensity level outside the vehicle to a reference light level, the reference light level based on a time of day.

15. A vehicle comprising:
a memory that stores computer-executable instructions; and
a processor configured to access the memory and execute the computer-executable instructions to perform operations comprising:
determining a geofence that encompasses a confined space; and
disabling, inside the confined space, operation of a first vehicle propulsion system of the vehicle in order to prevent gaseous emissions and/or sound emissions produced by the first vehicle propulsion system.

16. The vehicle of claim 15, wherein the first vehicle propulsion system is an internal combustion engine and wherein the sound emissions by the first vehicle propulsion system comprises a sound produced by the internal combustion engine.

17. The vehicle of claim 15, wherein the first vehicle propulsion system is an internal combustion engine and wherein the processor is further configured to access the memory and execute the computer-executable instructions to perform operations comprising:
detecting a location of the vehicle outside the geofence; and
enabling operation of the internal combustion engine based on detecting the location of the vehicle outside the geofence.

18. The vehicle of claim 15, wherein the vehicle is a hybrid electric vehicle that includes a second vehicle propulsion system comprising a battery coupled to an electric motor, and wherein the processor is further configured to access the memory and execute the computer-executable instructions to perform operations comprising:
determining that a charge level of the battery is below a threshold level; and
enabling, inside the confined space, operation of the first vehicle propulsion system based on determining that the charge level of the battery is below the threshold level.

19. The vehicle of claim 15, wherein the vehicle is a hybrid electric vehicle that includes a second vehicle propulsion system comprising a battery coupled to an electric motor, and wherein the processor is further configured to access the memory and execute the computer-executable instructions to perform operations comprising:
determining that a charge level of the battery is below a threshold level; and
displaying, upon a display screen of an infotainment system in the vehicle and/or a personal communications device, an instruction to charge the battery before the vehicle is started.

20. The vehicle of claim 15, wherein disabling operation of the first vehicle propulsion system is based on determining that the vehicle is parked inside the confined space, the determining based on comparing a light intensity level outside the vehicle to a reference light level, the reference light level based on a time of day.
